(19) United States
(12) Patent Application Publication
(10) Pub. No.: US 2003/0200201 A1
(43) Pub. Date: Oct. 23, 2003

(54) Dynamic offer presentation and server validation during device setup process

(75) Inventor: Daniel C. Milius, Huntington Beach, CA (US)

Correspondence Address: GATEWAY, INC., ATTENTION: IP LAW GROUP (MAIL STOP SD-21), 14303 GATEWAY PLACE, POWAY, CA, 92064, US

(73) Assignee: Gateway, Inc.

(21) Appl. No.: 10/127,895

(22) Filed: Apr. 23, 2002

(51) Int. Cl. G06F 17/30

(52) U.S. Cl. 707/3

(57) ABSTRACT

The disclosed system is a method and system for providing an offer on an electronic device. Initial offer data is selected based on data collected during entry of an order for an electronic device. The initial offer data is stored in a memory storage device for retrieval by the electronic device. The initial offer data is presented to a user of the electronic device. The user may then accept the initial offer. One or more additional offers may be provided to the electronic device, the one or more additional offers based on the data collected during entry of the order for the electronic device.

### FIELD OF THE INVENTION

The invention comprises a dynamic offer presentation and server validation system and method. Specifically, the invention comprises a system and method for presenting offers to users of electronic devices, such as personal computers, during the setup process for the device, and for performing validation of offers based on data stored on a server.

### BACKGROUND OF THE INVENTION

After acquiring a new electronic product, the typical consumer wants simply to plug the product in, or charge its batteries, and start using it. Before this can occur, however, the consumer must go through the process of unpacking, connecting, and configuring the product. This initial experience, often referred to as the “out-of-box experience” (or OOBE), has been frustrating for consumers in the past.

This initial experience can create a lasting impression with the user. A good experience will not only reaffirm the consumer's decision to purchase that particular product, but also may affect the purchase of later products and peripherals for the product. Companies have invested a lot of money in making this process more user-friendly for users with varied technological skill and experience. For example, improvements have been made in packaging, such as minimizing the use of internal packaging, packaging the products in box sizes appropriate for the customer's transportation modes, and providing a list of the contents of each box.

Manufacturers have also attempted to streamline the setup and configuration procedures. The number of necessary set-up tasks have been decreased, with the manufacturer often performing much of the set-up procedures at the factory or at the point-of-sale location. Easy to follow instructions, diagrams, and color-coded parts are often used to allow for a setup requiring minimal effort on the part of the user, with little or no opportunities for mistakes.

However, even after the product has been so pre-configured, the consumer must obtain and load the desired software programs onto the system before the product can be used as intended. This can include word processing, drawing, and financial planning programs. For new products, called electronic devices herein, such as personal computers, personal digital assistants (PDAs), or net appliances, one of the first applications that a user will typically want install and configure is internet access software. Setting up a device to use an internet service provider (ISP) can be a fairly complex and lengthy process for a user. Part of the process may include choosing an ISP that has service available in the area.

On typical systems, the computer may be generically configured with installer software programs for different ISPs represented by icons appearing on the desktop or main display screen of the electronic device. The user may select the ISP of their choice for installation by selecting an icon on the screen. The configuration process for that ISP is then initiated. Part of the configuration process may include selecting a local access number (analog or ISDN for example) for communications with the ISP. Some ISPs may not even have a local access number for a particular user, or the user may inadvertently select an access number, causing the user to pay unnecessary long distance charges when using the internet.

Another common problem with user configuration of the ISP access software is that the user may not be knowledgeable enough to select the proper parameters regarding the communications hardware. Very often, the ISP access software must be configured according to, for example, the type of modem or digital communicator used with the user's electronic device or computer, whether that device is internal or external. Sometimes, the user is forced to abandon the configuration process because the electronic device has to be opened to see what kind of internal communicator device is present. Other parameters which the user may not be familiar enough with to configure include bit rates, number of channels, communications protocol, etc.

Thus, a system which is pre-configured for a desired ISP based on data collected at a point of sale of an electronic device is desirable. A system that dynamically provides offers to the user based on the collected data is further desirable.

### SUMMARY OF THE INVENTION

The disclosed system is a method and system for providing an offer on an electronic device. Initial offer data is selected based on data collected during entry of an order for an electronic device. The initial data is stored in a memory storage device for retrieval by the electronic device. The initial offer data is presented to a user of the electronic device. The user may then accept the initial offer. One or more additional offers may be provided to the electronic device for presentation and acceptance by the user, the one or more additional offers based on the data collected during entry of the order for the electronic device.

### BRIEF DESCRIPTION OF THE FIGURES

The components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a representative block diagram illustrating a network structure that can be used for implementing the system of the present invention;

FIG. 2 is a representative block diagram illustrating components in the server of FIG. 1;

FIG. 3 is a representative block diagram showing components of an electronic device of FIG. 1;

FIG. 4 is a representative block diagram showing an access number lookup table of the server of FIG. 1;

FIG. 5 is a representative block diagram showing an electronic device of FIG. 1 in the form of a personal computer; and

FIG. 6 is a flow diagram illustrating a method performed by the system of FIG. 1.

### DETAILED DESCRIPTION OF THE PREFERRED EMBODIMENT(S)

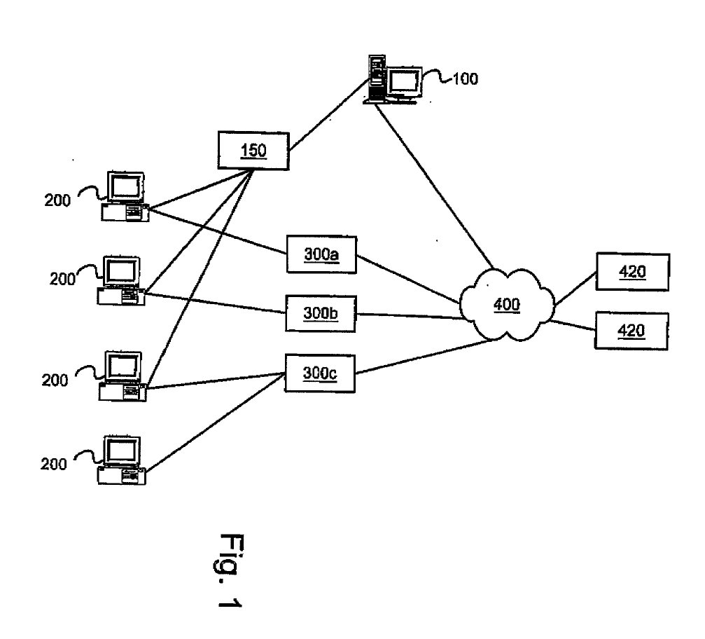

With reference to FIG. 1, a block diagram illustrating a network structure that can be used for implementing the system of the present invention is shown. A server 100 is connectable to a communications device 150 having multiple ports allowing a plurality of electronic devices 200, such as personal computers, to communicate with the server 100. The server 100 may comprise a high-end personal computer, a mid-range size computer, or a main frame computer. The communications device 150 allows each of the electronic devices 200 to communicate with the server 100 through a dedicated connection. The server 100 is also connectable to a network 400 through a separate communications device or channel. The network 400 comprises the internet or other wide area network.

Internet service providers (ISPs) 300a-300c are connectable to the network 400. Each of the electronic devices 200 are capable of connection to one or more of the ISPs 300a-300c. Each ISP 300a-300c may have several access lines, the selection of which for access to each ISP 300a-300c may depend on geographic region or the area code where the electronic device 200 accessing the ISP 300a-300c is located.

Also connectable to the network 400 are a plurality of other servers 420 which may store advertisement or offers for goods or services for presentation to users (called offers herein) of the electronic devices 200. Each of the offers may comprise HTML based data (offer data) for downloading from the servers 420 to one or more of the electronic devices 200 for presentation to users on a display on the electronic device, such as a cathode ray tube or liquid crystal display.

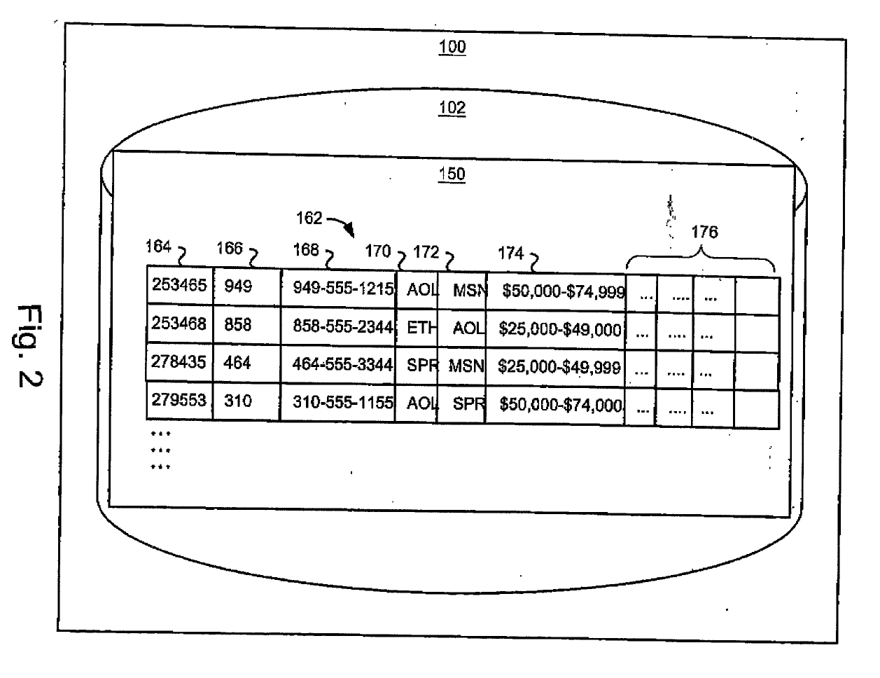

With reference to FIG. 2, a block diagram illustrating components in the server 100 is shown. The server 100 includes a memory storage device 102, for example a hard disk drive, also called a memory device herein. A database 150 is stored in the memory storage device 102. A table 162 in the database 150 is for storing data collected when each electronic device 200 is ordered from the manufacturer. The collected data is stored in a customer record 160. Each record 160 contains fields for storing the collected data, which can be used for selecting offers for goods and services (called offers herein) to present to the users of the electronic devices 200.

One such offer includes an offer for the user to sign up for one of the internet service providers (ISPs) 300a-300c. One field in the record 160 contains the customer ID 164. Another field 166 contains the area code where the electronic device will be used. One field may contain the code for a preferred ISP 170 and another the code for a secondarily preferred ISP 172. The data for fields 170 and 172 may have been entered based on a user's preferences indicated when the electronic device 200 was ordered. In field 168, an access number for the primary ISP 170 is stored.

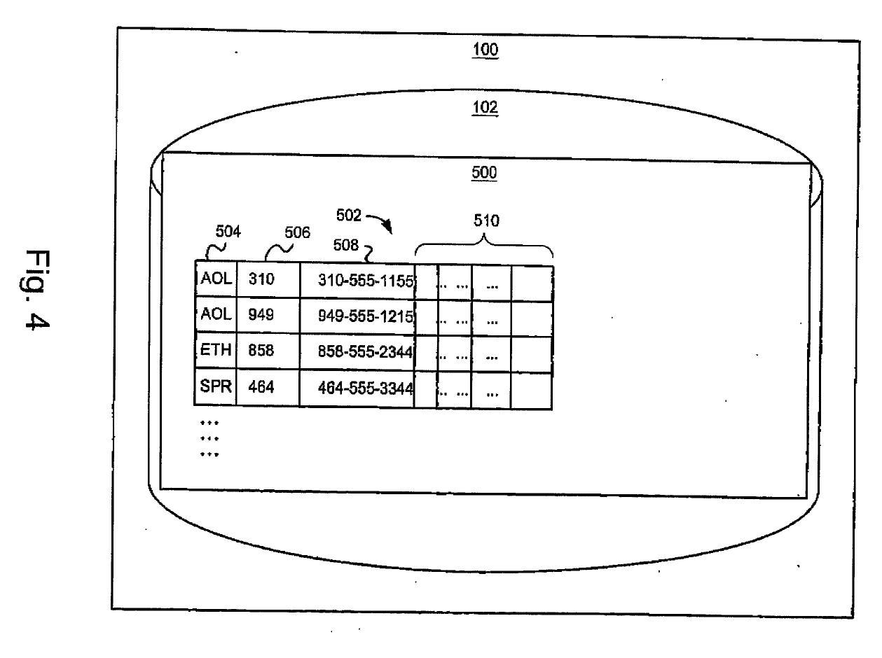

With reference to FIG. 4, the access number 168 is one that was selected from an access number lookup table 502 based on the primary ISP 170 and area code 166 of the user of the electronic device 200. The access number lookup table is also stored in the database 150 stored on the storage device 102 in the server 100. When the user places an order or purchases an electronic device 200, the data stored in the table 162 of FIG. 2 is collected. The access number lookup table 500 is searched based on the preferred ISP 170 and area code 166. The access number lookup table 502 has searchable fields 504 and 506 which contain a listing of the available ISPs and area codes 506 respectively. When the preferred ISP and area code are searched using fields 504 and 506, a matching access number 508 is retrieved from the table 502. Other fields 510 in the access number lookup table 502 contain parameters used for configuring the electronic device 200 for using the ISP 300a-300c, called configuration parameters herein.

With reference back to FIG. 2, the access number retrieved from the access number lookup table 502 is stored in the record 160 for the user data being processed. Other data may be stored in fields of the customer record 160 that may be useful for selecting offers such as salary information 174 of the user and other data 176 associated with the user and/or the electronic device and its use.

The selected ISP related data stored in each record 160 of the table 162 can be viewed as initial offer data stored in the memory device 102. As described above, the initial offer data was thus selected based on the data collected during entry of the order for the electronic device 200. The electronic device 200 is capable of displaying the initial offer data on a display device for displaying the initial offer data to a user, such as a cathode ray tube or liquid crystal display device connected to or on the electronic device 200. Further, the electronic device 200 comprises an input device, such as a keyboard or pen top device, for allowing a user to input acceptance of the initial offer and transmitting the acceptance in the form of acceptance data to the server 100. The electronic device 200 comprises a communications device for receiving the initial offer data from the communications device 150 of server 100, and for transmitting the acceptance data back to the communications device 150 of server 100 for processing by the server 100, and for receiving a confirmation of the acceptance from the server 100.

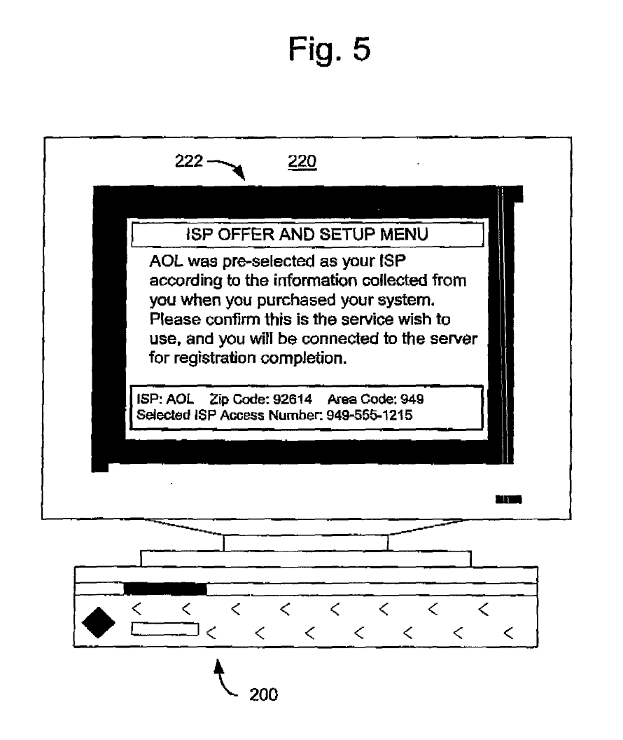

With reference to FIG. 5, an electronic device 200 in the form of a personal computer is shown. The electronic device 200 includes a display 220, which may comprise a cathode ray tube or liquid crystal display, having a screen 222 where graphics and text are displayed. Depicted in FIG. 5, the screen 222 currently displays the initial offer which is an offer to the user to sign up for internet service by one of the ISPs 300a-300c. Some of the user's information initially entered when the electronic device 200 was ordered is displayed at the bottom of the screen 222 along with the selected access number.

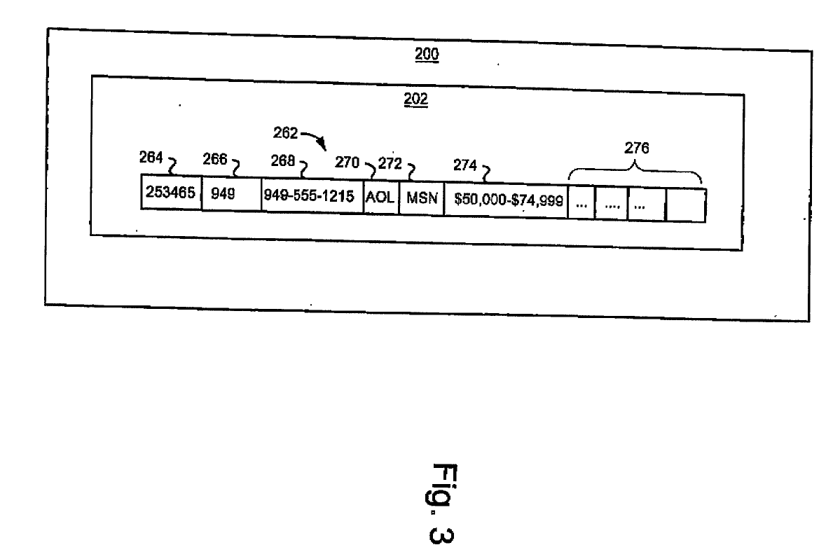

With reference to FIG. 3, a block diagram showing components of the electronic device 200 is shown. The electronic device 200 includes a memory device 202 which is capable of storing at least some, if not all, of the data collected pertaining to the specific electronic device 200 when the electronic device 200 was ordered from the manufacturer. The storage device 202 may comprise a memory area in the electronic device's basic input/output system (BIOS), or in an area on another type of memory device such as a hard disk, or removable storage that is shipped with the electronic device 200 or shipped to the user after processing the collected data. The storage device 202 contains a single record 260 having the collected data. The record 260 at least contains the customer ID 264 for identifying the user/electronic device 200. Alternatively to storing the data collected during entry of the order for the electronic device 200 in the server only, the collected data may be stored in the storage device 202 of the electronic device 200 in the single record 260. In this alternative embodiment, the record 260 contains the same fields as would the server data records 160. In addition to the customer ID 264, the data record 260 stores the area code 266, preferred ISP 270, secondarily preferred ISP 272, and other user or electronic device information, such as, for example, the user's annual salary 274 and other data in fields 276. Further, when the access number 508 is selected from the access number table 502, it is downloaded into an access number field 268 in record 260 in the data storage device 202 in the electronic device 200.

Therefore, with this information complete as stored in the electronic device 200, the initial offer data may be complete on the electronic device 200 alone. When the electronic device 200 accesses the server's communication's device 150, with all of the information present in the memory storage device 202 of the electronic device 200 to present the initial offer, server 100 then acts as a verification and confirmation device to complete acceptance and configuration of the initial offer. Updated configuration parameters may be downloaded at the time of verification in order to provide for changes in the ISP service which may have occurred since the electronic device was shipped or provided to the user.

In any case, whether the initial offer and other data is stored on the server 100 or the electronic device 200, or both for verification, the system offers better security and may be used to prevent, for example, abuse of discount offers and codes provided by ISPs. With the server storing the customer ID, 164 which must be matched to the customer ID 264 in order for the server to confirm the initial offer, users may not trade discount codes which commonly occurs today without the system of the present invention. If the user accepts the initial offer, then the server 100 validates the acceptance by this confirmation process. The validation is transmitted to the electronic device in the form of validation data for presentation to the user. Other offer codes may be stored in fields 176 on the server, which must be matched to one or more offer codes stored on the electronic device 200 in fields 276, and preferably, the customer ID 164, to provide added security.

As the described system can be leveraged for presenting an initial offer on the electronic device 200, additional offers may be presented. As with the first embodiment described above, the communications device of the electronic device 200 may be used for receiving one or more additional offers based on the data collected during entry of the order for the electronic device 200. The data stored in database 150 on the server 100 may, in this way, be a valuable commodity. The other server 420 may be given access to the database 150 through network 400. By analyzing the collected data, each server 420 may make a determination as to whether to offer its services. For example, one of the servers 420 may comprise a credit card issuer that may read users' salary information 174 from the records 160 of the database 150, to determine if credit card offers should be sent to the electronic devices 200. These additional offers may be arbitrated through the server 100 through the network 400 so that the additional offers may be transmitted to an electronic device 200 even before configuration of service for the ISP 300a-300c. Otherwise, the ISP 300a-300c may be coordinated with the server 100 so that the offer may be transmitted through the selected ISP 300a-300c sometime after configuration. Otherwise, the database 150 may store the additional offer data directly for transmission to the selected electronic devices 200.

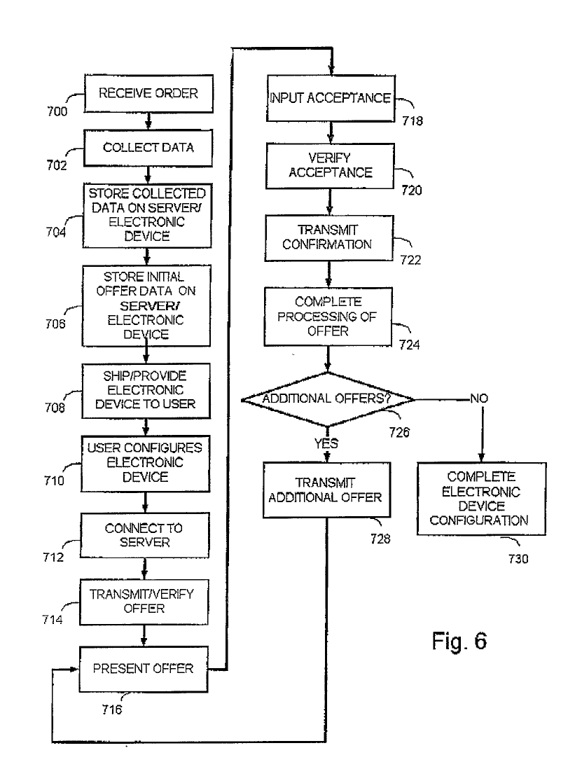

With reference to FIG. 6, a flow diagram illustrating a method performed by the system of FIG. 1 is shown. An order is received at a point of sale for an electronic device 200, step 700. Data regarding the user and the electronic device 200 configuration is collected, step 702. The collected data is stored on the server 100, step 704. Initial offer data is stored on the server 100 in one embodiment, including, for example, an offer for a selected ISP 300a-300c, including access code or number data 168, which was selected based on the user's area code 166, step 706. In an alternative embodiment, just verification data such as offer codes or the customer ID 164 is stored on the server 100 with respect to the electronic device 200 ordered.

The collected data may be stored on the electronic device in step 704 instead of the server or in addition to storage on the server. In the alternative embodiment, the initial offer data is stored on the electronic device in step 706.

The electronic device 200 is shipped to the user, step 708. The user configures the electronic device, step 710. During configuration, the electronic device 200 connects to the server 100. The initial offer is transmitted to the electronic device 200, if resident on the server 100, or the initial offer is verified by the server 100 if resident on the electronic device 200, step 714. The offer is then presented to the user, step 716. The user may then input an acceptance of the offer, step 718. The acceptance is verified, or validated, by the server 100 as explained above, step 720. The confirmation, or validation data, is transmitted to the electronic device 200, step 722. Processing of the offer and acceptance can then be completed, step 724, which may include, for example, final configuration of parameters for using an ISP 300a-300c.

The server 100 checks for whether additional offers are to be sent to the electronic device 200, step 726. For example, one of the servers 420 may have searched the database 150 of collected data to find users that qualify for offers from the server 420. A flag is set with respect to each user that so qualifies. If an additional offer is to be transmitted, then it is transmitted to the electronic device 200, step 728. Processing then moves to step 716. Otherwise, if there are no offers for transmission, then the electronic device 200 returns to completing configuration, step 730.

It will thus be seen that changes may be made in carrying out the above system and method and in the construction set forth without departing from the spirit and scope of the invention. It is intended that any and all matter contained in the above description and shown in the accompanying drawings shall be interpreted as illustrative and not in a limiting sense.

What is claimed is:

1. An electronic device, comprising:
a memory device; and
initial offer data stored in the memory device, the initial offer data selected based on data collected during entry of an order for the electronic device.

2. The electronic device of claim 1 comprising a display device for displaying the initial offer data to a user.

3. The electronic device of claim 2 comprising an input device for allowing a user to input acceptance of the initial offer.

4. The electronic device of claim 3 comprising a communications device.

5. The electronic device of claim 4 wherein the communications device is for transmitting the acceptance to a server.

6. The electronic device of claim 5 wherein the communications device is for receiving confirmation of the acceptance from the server.

7. The electronic device of claim 1 wherein the communications device is for receiving one or more additional offers based on the data collected during entry of the order for the electronic device.

8. The electronic device of claim 1 wherein the initial offer comprises an offer to use an internet service provider.

9. The electronic device of claim 8 wherein the initial offer further comprises configuration parameters for using the internet service provider.

10. A server, comprising:
a communications device for receiving initial offer acceptance data from an electronic device; and
a database for storing data collected during entry of an order for the electronic device, the collected data for validating the received initial offer acceptance data.

11. The server of claim 10 wherein the communications device is further for transmitting validation data to the electronic device after the received initial offer acceptance data is validated.

12. The server of claim 10 wherein the database is further for storing one or more additional sets of offer data.

13. The server of claim 12 wherein the communications device is further for transmitting each of the one or more additional sets of offer data that are selected based on the data collected during entry of the order for the electronic device.

14. The server of claim 11 wherein the initial offer comprises an offer to use an internet service provider.

15. The sever of claim 14 wherein the validation data further comprises internet service provider parameter data for assisting a user the electronic device with configuration of the internet service provider.

16. A method for providing an offer, comprising;
selecting initial offer data based on data collected during entry of an order for an electronic device;
storing the initial offer data in a memory device for retrieval by the electronic device.

17. The method of claim 16 comprising presenting the initial offer data to a user of the electronic device.

18. The method of claim 17 comprising receiving an acceptance of the initial offer from the user.

19. The method of claim 18 comprising confirming the acceptance of the initial offer.

20. The method of claim 16 comprising transmitting one or more additional offers to the electronic device, the one or more additional offers based on the data collected during entry of an order for the electronic device.

21. The method of claim 16 wherein the initial offer comprises an offer to use an internet service provider.

22. The method of claim 21 wherein the initial offer further comprises configuration parameters for using the internet service provider.
